(19) United States
(12) Patent Application Publication
(10) Pub. No.: US 2013/0147411 A1
(43) Pub. Date: Jun. 13, 2013

(54) SYSTEM AND METHOD FOR CONTROLLING FANS

(71) Applicants: WEI PANG, Shenzhen City (CN); JIE LI, Shenzhen City (CN)

(72) Inventors: WEI PANG, Shenzhen City (CN); JIE LI, Shenzhen City (CN)

(21) Appl. No.: 13/628,071

(22) Filed: Sep. 27, 2012

(30) Foreign Application Priority Data
Dec. 8, 2011 (CN) 201110405868.6

(51) Int. Cl. G05D 23/20

(52) U.S. Cl. 318/452; 318/472

(57) ABSTRACT

A system for controlling fan speed, wherein fans are employed to dissipate heat generated by a plurality of hard disk drives divided into groups, includes a temperature sensor detecting an overall temperature where the hard disk drives are arranged, a control unit obtaining a number of operating hard disk drives in each group, and a baseboard management controller (BMC) storing ratios corresponding to different temperatures and different numbers of operating hard disk drives in each group. The BMC obtains the temperature from the temperature sensor and the number of operating hard disk drives in a group, and obtains a ratio from a preset table according to the temperature and the number of operating hard disk drives in the group, to adjust the speed of the fan.

### BACKGROUND

1. Technical Field

The present disclosure relates to a system and a method for controlling fans.

2. Description of Related Art

A plurality of hard disk drives arranged in a server provides more storage capacity. The more hard disk drives the server has, the more heat is generated by the hard disk drives, especially when the hard disk drives are operating. Consequently, more fans are employed to dissipate the heat. For example, every five hard disk drives constitute one group, and one fan is employed to dissipate the heat generated by that group of hard disk drives. However, the working states between different groups may be different, such as three hard disk drives operating in one group, while there is only one hard disk drive operating in another group, which results in an unbalanced method of dissipating heat.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a system for controlling fans of the present disclosure.

FIG. 2 is a flow chart of an embodiment of a method for controlling fans of the present disclosure.

### DETAILED DESCRIPTION

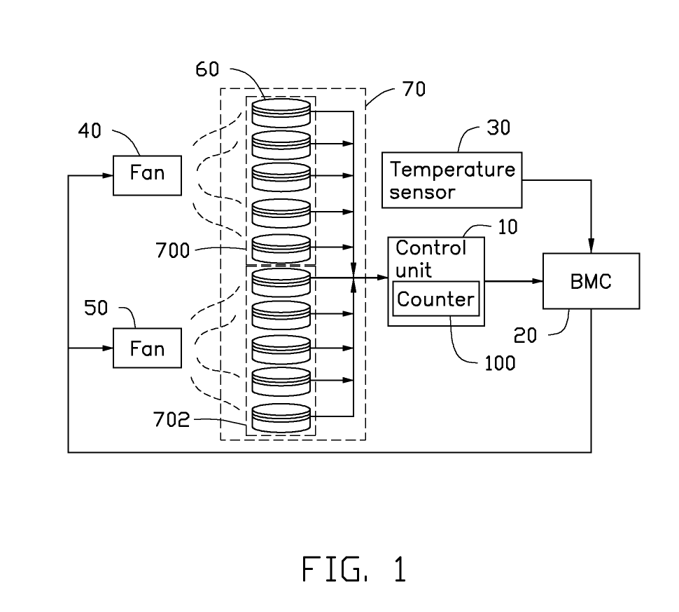

FIG. 1 illustrates an embodiment of a system of the present disclosure. The system is applied to control the speeds of a plurality of fans dissipating heat generated by a plurality of hard disk drives 60 that are arranged on a hard disk drive area 70 of a server. The system includes a control unit 10 obtaining the working status of each hard disk drive 60, a temperature sensor 30 sensing the temperature of the hard disk drive area 70, and a baseboard management controller (BMC) 20 employed to adjust the speed of the fans according to the temperature and the number of the hard disk drives 60 that are operating.

In the embodiment, the hard disk drive area 70 contains ten hard disk drives 60 which are divided into two groups, a first group 700 and a second group 702. A fan 40 of the plurality of fans is employed to dissipate heat generated by the hard disk drives 60 of the first group 700, and a fan 50 of the plurality of fans is employed for dissipating heat generated by the second group 702.

According to the working principle of the hard disk drive, a hard disk drive will output the code “01010101 . . . ” from a default pin, such as an activity signal pin, when the hard disk drive is operating, such as performing a writing or reading operation, and outputs the code “1111 . . . ” or the code “0000 . . . ” from the default pin when the hard disk drive is idle. Thus if the output is a repeating “01” binary code, the hard disk drive is operating, and if the output is a continuous “00” or “11” binary code, the hard disk drive 60 is idle.

In the embodiment, the control unit 10 is a complex programmable logic device (CPLD). The control unit 10 obtains the working status of all the hard disk drives 60 within one group on a cyclical basis, such as, in a round-robin polling or scheduling. A counter 100 in the control unit 10 is employed to calculate the number of the hard disk drives 60 which are actually operating. For instance, when the counter 100 of the control unit 10 is to calculate the number of the hard disk drives 60 which are operating in the first group 700, the control unit 10 obtains the code output from the activity signal pin of a first hard disk drive 60 in the first group 700, and determines whether the first hard disk drive 60 is operating, that is the control unit 10 determines whether the code output from the first hard disk drive 60 is the repeating “01” binary code. If the first hard disk drive 60 is found to be operating, the counter 100 is increased by 1. The control unit 10 then obtains the code output by a second hard disk drive 60 of the first group 700, and if the second hard disk drive 60 is also operating, the counter 100 receives another increment of 1. The control unit 10 obtains the working status of all the other hard disk drives 60 of the first group 700 in the same manner as described above. Having obtained the status of all of the hard disk drives 60 in the first group 700, the control unit 10 transmits the total of the counter 100 to the BMC 20. The BMC 20 is configured to adjust the speed of the fan 40 by referring to the counter 100.

The temperature sensor 30 samples the temperature of the hard disk drive area 70.

The BMC 20 controls the speed of the fans 40 and 50 with a pulse signal. In the embodiment, the duty cycle of the pulse signal is divided into a plurality of levels, such as 10 levels. Each level corresponds to a ratio. For example, one ratio represents a pulse signal with 0.1 duty cycle, and three ratios represents a pulse signal with 0.3 duty cycles. In other embodiments, the pulse signal may be divided into more levels, to add more precision and accuracy to the fan speed adjustment.

During a design period of the server, the required speed of the fans 40 and 50 can be determined according to the different temperatures and the different numbers of the hard disk drives 60 operating or not operating in the first and second groups 700 and 702. The ratio can be determined according to a number of factors. In the embodiment, the ratios corresponding to the different temperatures and the different numbers of the hard disk drives 60 which might or might not be operating are stored in a table of the BMC 20.

When the server is working, the control unit 10 is employed to adjust the speed of the fans 40 and 50. The control unit 10 determines the working status of the hard disk drives 60 by obtaining the codes output by the hard disk drives 60. If the code is a repeating “01” binary code, the control unit 10 adds 1 to the counter 100. After obtaining the code outputs of all the hard disk drives of a group in the round-robin polling or scheduling, the control unit 10 transmits the total of the counter 100 to the BMC 20. The BMC 20 obtains the temperature of the hard disk drive area 70 from the temperature sensor 30. The BMC 20 then acquires the ratio corresponding to the temperature and the number of the hard disk drives 60 which are operating from the pre-stored table, and transmits an appropriate pulse signal to the fan.

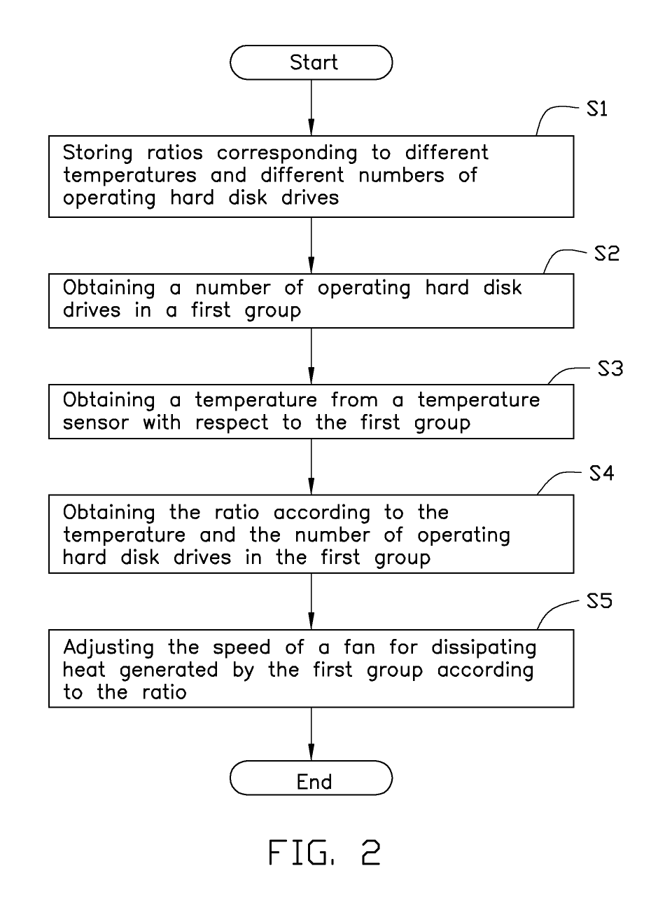

FIG. 2 illustrates a method for controlling fans of the present disclose, the method includes steps as follow.

In step S1, storing ratios corresponding to different temperatures and different numbers of operating hard disk drives in a table of the BMC 20.

In step S2, the control unit 10 obtaining a number of operating hard disk drives in a first group.

In step S3, obtaining a temperature from the temperature sensor 30.

In step S4, obtaining the ratio according to the temperature and the number of operating hard disk drives from the pre-stored table.

In step S5, adjusting the speed of a fan dissipating heat generated by a group according to the ratio.

While the disclosure has been described by way of example and in terms of preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A system for controlling fans, wherein the fans are employed to dissipated heat generated by a plurality of hard disks that are divided into different groups, the system comprising:
a temperature sensor detecting a temperature where the hard disk drives are arranged;
a control unit obtaining the number of operating hard disk drives in each group; and
a baseboard management controller (BMC) storing ratios corresponding to different temperature and different number of operating hard disk drives of each group, wherein the BMC obtains the ratio according to the temperature and the number of operating hard disk drive, thereby to adjust the speed of the fan to dissipate heat generated by each group according to the ratio.

2. The system of claim 1, wherein the ratios corresponds to different levels of the duty cycle of a pulse signal.

3. The system of claim 1, wherein the control unit is a complex programmable logic device (CPLD).

4. The system of claim 1, wherein the control unit includes a counter, the counter of the control unit is used to calculate the number of operating hard disk drives of the group in round-robin polling or scheduling.

5. The system of claim 1, wherein the ratios corresponding to different temperature and different number of operating hard disk drives of each group are stored in a table of the BMC.

6. A method for controlling fans, wherein the fans are employed to dissipated heat generated by a plurality of hard disk drives divided into different groups, the method comprising
storing ratios corresponding to different temperatures and different numbers of operating hard disk drives in a BMC;
obtaining a number of operating hard disk drives in a first group by a control unit;
obtaining a temperature from a temperature sensor with respect to the first group;
obtaining the ratio according to the temperature and the number of operating hard disk drives in the first group; and
adjusting the speed of a fan for dissipating heat generated by the first group according to the ratio.

7. The method of claim 6, wherein the control unit is a complex programmable logic device (CPLD).

8. The method of claim 6, wherein the control unit includes a counter, the control unit is to calculate the number of operating hard disk drives of a group in round-robin polling or scheduling, and stores the number in the counter.

9. The method of claim 6, wherein the ratios corresponding to different temperature and different number of operating hard disk drives of each group are stored in a table of the BMC.
